(19) United States
(12) Patent Application Publication
(10) Pub. No.: US 2022/0280381 A1
(43) Pub. Date: Sep. 8, 2022

(54) CARDIOPULMONARY RESUSCITATION DEVICES WITH A COMBUSTION UNIT AND ASSOCIATED METHODS

(71) Applicant: NuLine Telemetry Holdings, LLC, Brentwood, TN (US)

(72) Inventor: George Edward Spivey, JR., Greeneville, TN (US)

(21) Appl. No.: 17/684,654

(22) Filed: Mar. 2, 2022

Related U.S. Application Data
(60) Provisional application No. 63/155,702, filed on Mar. 2, 2021.

(51) Int. Cl. A61H 31/00

(52) U.S. Cl. CPC A61H 31/006; A61H 2201/1246

(57) ABSTRACT

CPR devices with a combustion unit and associated methods are disclosed. According to an aspect, a CPR device includes a first mechanism configured to attach to a torso of a patient for providing chest compressions to the patient. The CPR device also includes a second mechanism comprising a piston and a shaft. The piston is movable within the shaft and is attached to the mechanism for movement of the mechanism when the piston moves within the shaft. Further, the CPR device includes a combustion unit operatively connected to the piston for powering the movement of the piston within the shaft. The combustion unit comprising a chamber configured to receive propellant. The combustion unit is configured to controllably ignite the propellant in the chamber for powering the movement of the piston.

### CROSS REFERENCE TO RELATED APPLICATION

This application claims priority to U.S. Provisional Patent Application No. 63/155,702, filed Mar. 2, 2021, and titled CARDIOPULMONARY RESUSCITATION DEVICES WITH A COMBUSTION UNIT AND ASSOCIATED METHODS, the content of which is incorporated herein by reference in its entirety.

### TECHNICAL FIELD

The presently disclosed subject matter relates generally to cardiopulmonary (CPR) devices. Particularly, the presently disclosed subject matter relates to CPR devices with a combustion unit and associated methods.

### BACKGROUND

CPR is an emergency procedure performed on a person suffering cardiac arrest. The procedure combines chest compressions often with artificial ventilation for preserving the person's organ functions until other measures can be taken to restore normal heart rhythm, or blood circulation, and breathing in the person. In the treatment, the person's chest (i.e., sternum) is compressed to in turn cause compression of the heart for forcing blood to circulate through the cardiovascular system. Also, in some cases, artificial ventilation may be provided by either exhaling air into the person's mouth or nose or using a CPR device that pushes air into the person's lungs (referred to as “mechanical ventilation”).

The administration of CPR is often part of first aid provided to an individual. First aid equipment are typically kept in places where a high number of people can be expected. For example, first aid equipment is typically maintained in an office building or a hotel so that it can be readily available for use in an emergency situation. Typically, there will be a maintenance or inspection schedule for the equipment to confirm its operation or possibly replace the equipment at the end of its expected shelf life. For at least these reasons, it is desired to provide CPR devices that have a long shelf life, minimal maintenance requirements, and low cost to encourage the placement of them in many environments.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a schematic diagram of a CPR device with a combustion unit in accordance with embodiments of the present disclosure;

FIGS. 2A, 2B, and 2C illustrate a top view, a side view, and an end view, respectively, of a patient positioning unit for use with the CPR device shown in FIG. 1 in accordance with embodiments of the present disclosure;

FIGS. 2D, 2E, and 2F illustrate a top view, a side view, and an end view, respectively, of another example patient positioning unit for use with the CPR device shown in FIG. 1 in accordance with embodiments of the present disclosure;

FIG. 3 is a flow diagram of example operation of a CPR device in accordance with embodiments of the present disclosure; and

FIGS. 4A-4E are diagrams of another example CPR device with a combustion unit in accordance with embodiments of the present disclosure.

### SUMMARY

The presently disclosed subject matter relates to CPR devices with a combustion unit and associated methods. According to an aspect, a CPR device includes a first mechanism configured to attach to a torso of a patient for providing chest compressions to the patient. As an example, the first mechanism can be placed beneath the sternum while in prone position. The CPR device also includes a second mechanism comprising a piston and a shaft. The piston is movable within the shaft and is attached to the mechanism for movement of the mechanism when the piston moves within the shaft. Further, the CPR device includes a combustion unit operatively connected to the piston for powering the movement of the piston within the shaft. The combustion unit comprising a chamber configured to receive propellant (e.g., hydrogen gas and oxygen gas). The combustion unit is configured to controllably ignite the propellant in the chamber for powering the movement of the piston.

According to another aspect, a method of CPR includes providing a CPR device including a first mechanism for providing chest compressions to a patient. The CPR device also includes a second mechanism comprising a piston and a shaft. The piston is movable within the shaft and is attached to the mechanism for movement of the mechanism when the piston moves within the shaft. Further, the CPR device includes a combustion unit operatively connected to the piston for powering the movement of the piston within the shaft. The combustion unit includes a chamber configured to receive propellant. The combustion unit is configured to controllably ignite the propellant in the chamber for powering the movement of the piston. The method includes attaching the first mechanism to a torso of the patient. As an example, the first mechanism can be placed beneath the sternum while in prone position. Further, the method includes operating the combustion unit to ignite and combust propellant in the chamber for moving the piston within the shaft to thereby move the first mechanism for providing chest compressions to the patient.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

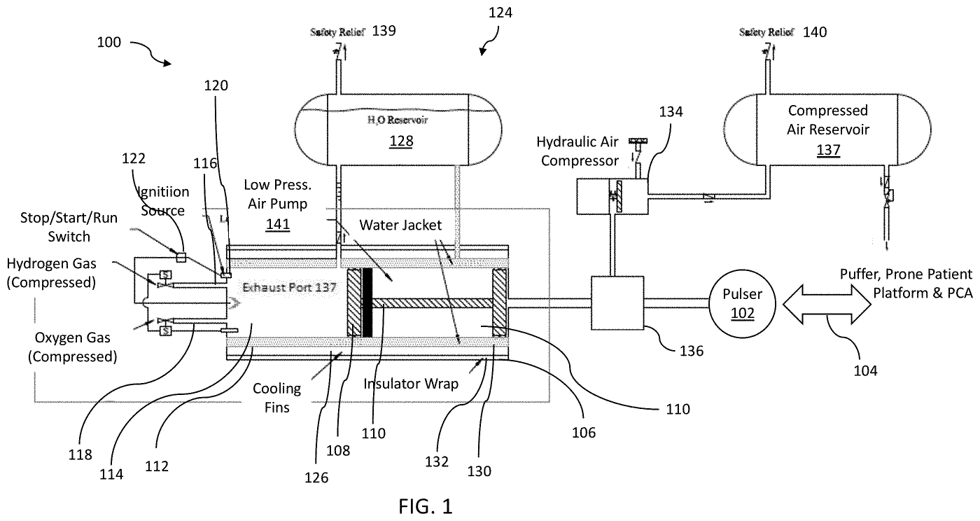

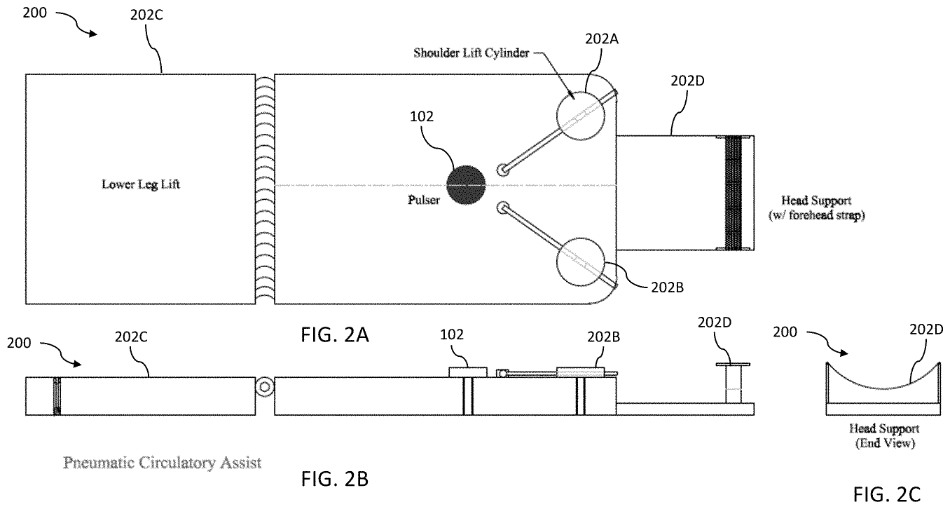

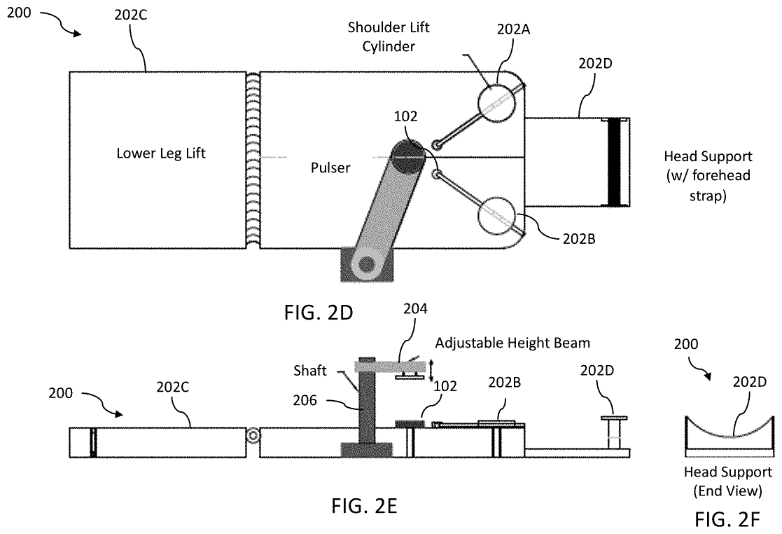

FIG. 1 illustrates a schematic diagram of a CPR device 100 with a combustion unit in accordance with embodiments of the present disclosure. Referring to FIG. 1, the CPR device 100 includes a pulser 102 or any other suitable mechanism configured to attach to a torso of a patient for providing chest compressions to the patient. For example, when operating to provide chest compressions to a patient as described in more detail herein, the pulser 102 can be moved back-and-forth generally in the directions indicated by double-sided arrow 104 and angularly as shown with the pivots shown near the pulser in FIG. 2A. The pulser 102 is operatively attached to a mechanism 106 including a piston 108 and a shaft 110 for moving the pulser 102 hydraulically via the IHCM 136.

The CPR device 100 includes a combustion unit 112 operating connected to the piston 108 for powering the movement of the piston 108 within the shaft 110. The combustion unit 112 includes a chamber 114 configured to receive a suitable propellant that can be delivered to the chamber 114 for controlled ignition to move the piston back-and-forth within the shaft 110 to thereby move the pulser 102 via hydraulics in the IHCM 136. The propellant in this example includes hydrogen gas and oxygen gas that are compressed and maintained in separate containers or the same container (not shown for ease of illustration). Power delivery is via the chamber 114 driving the piston 108 to generate hydraulic pressure and operate a low pressure cooling air pump as described in further detail herein. The hydrogen gas and oxygen gas can be delivered to the chamber 114 via respective tubes 116 and 118. A suitable controller (not shown) can be used to control the amounts, timing, and/or rate of flow of the hydrogen gas and the oxygen gas to the chamber 114 to thereby control and power movement of the pulser 102 once the propellant is ignited. An ignition source or igniter 120 can control the ignition of the propellant to thereby control the movement of the pulser 102. The controller can operate the combustion unit 112 to control powering of the movement of the piston for controlling movement of the pulser 102 according to a predetermined compression regimen for the patient. A stop/start, run switch 122 can be a user interface and control for a user to operate the ignition of the propellant. The emission from the combustion is water vapor, which is inert and safe in confined transport environments.

In accordance with embodiments, the piston 108 is configured to move between two extreme positions when the propellant is ignited in a cycle. The pulser 102 is thereby moved hydraulically between two corresponding extreme positions. In one extreme position, the pulser 102 is in contact with the torso of the patient, and in another extreme position the pulser 102 is retracted to a position away from the torso. The pulser 102 can thereby be controlled by ignition of the hydrogen and oxygen to move in a cycle between the extreme positions to provide compressions to a patient suffering cardiac arrest.

In accordance with embodiments, the CPR device 100 includes a cooling unit 124 configured to transfer heat from the piston 108/shaft 110 mechanism and/or the combustion unit 112. For example, the cooling unit 124 may include a set of cooling fins 126 attached to the piston 108/shaft 110 mechanism and/or the combustion unit 112 for transferring heat from them to the surrounding air. Further, for example, the cooling unit 124 may include a fluid cooling unit having a water reservoir 128 and water jacket 130. Another example is glycol. The water jacket 130 can hold water and it substantially surrounds the piston 108/shaft 110 mechanism and/or the combustion unit 112 for receipt of heat therefrom. The water reservoir 128 can deliver cooled water to the water jacket 130 and receive heated water from the water jacket 130 for cooling in the reservoir 128.

In accordance with embodiments, the piston 108/shaft 110 mechanism and/or the combustion unit 112 may be covered by an insulator wrap 132 to prevent accidental contact burns.

In accordance with embodiments, the CPR device 100 includes an air compressor 134 configured to provide ventilation to a patient. Due to the difficulty of metering precise gas inputs, cycle energy is set to exceed the maximum pulser 102 requirements allowing excess combustion energy to be redirected to the hydraulicly driven compressor 134. The impulse profile can be regulated via hydraulics in the IHCM 136 to match CPR specifications and to provide impulse delivery to the pulser 102. An electrical spark generation unit 136 (e.g., integrated hydraulic control module (IHCM)) can convert mechanical power generated by the combustion unit 112 to hydraulic power for use by the air compressor 134. A compressed air reservoir 137 may store compressed air for use by the air compressor 134. Particularly, the air compressor 134 may be operatively connected to the reservoir 137 for receiving and delivering the compressed air to the patient and combustion chamber if the oxygen tank is depleted. There can be operability to regenerate gas injection and spark to continue cycle via internal components. There can be a spring return for the piston. A manifold can be in place to allow replacement of the IHCM 136 and piezo banks to alter operation should CPR specifications change.

The compressed air reservoir 137 can store compressed air generated from excess combustion energy to run pneumatic circuitry for puffer and to provide air to puffer if O₂ supply is exhausted.

Exhaust Port 137 can have a cylinder wall opening to relieve pressure, sending combustion exhaust out through reed valve similar to 2 stroke engine exhaust.

Hydraulic Air Compressor 134 can convert excess energy from IHCM to compressed air for other operations.

Low Pressure Air Pump (LPAP) 141 can use piston stroke to deliver low pressure air for cooling purposes via reed valve intake and exhaust ports.

The liquid H₂O reservoir 128 can act as muffler by condensing steam into water thereby dissipating sound wave impulse before releasing via relief valve. The mechanism 202D can support a patient's head in downward, or to left and right to allow for better regurgitation clearance.

The IHCM 136 is a cam actuated manifold with interchangeable valve banks where the position of the drive shaft from piston coordinates hydraulic, propellant and electrical activities throughout the cycle. Activities include: regulating even pressure delivery to the pulser 102 by shunting excess propulsion energy to HAC 134. Internal cams trigger valves regulating gas injections, piezo for spark generation, generation, provides spring return for piston. It receive measurement from AHB 204 to regulate Pulser 102 parameters. It can provide manual controls for LBCS and UBCS. Note: All parameters set by AHB 204 can also have valving to allow for manual overrides.

Integrated Pneumatic Control Module 142 can be a manifold with interchangeable valve banks that governs pneumatic operations. It can be powered initially by O₂ and then by HAC 134. Its functions can include governance of puffer ventilation pressure and timing. It can adjust parameters based on AHB 204 input. Note: All parameters set by AHB 204 also will have valving to allow for manual overrides. Pneumatic circuitry can be powered by O₂ cylinder until CAR 136 has sufficient pressure to take over operations, thereby reserving O₂ for puffer.

A Lower Body Compression System (not shown) can be powered by HAC 134. It can be attached to PPP 200 and can be zipped on patient similar to ski pants. HAC 134 supplies sufficient pressure to inflate internal air bags to provide compression to extremities to maximize blood volume to torso and head. It can also provide direct compression for lacerations and immobilize skeletal fractures.

A Low Pressure Air Pump 141 uses piston stroke to deliver low pressure air for cooling purposes.

The PPP 200 can be a multi-function device that allows prone placement of patient over the pulser 102. Further, the PPP 200 can allow placement of SLC 202A & 202B under shoulders. Further, it allows placement of patients legs on LLL 202C for elevation to improve blood flow to torso and head. It also allows placement of provide pneumatic compression on arms and from hips.

The pulser 102 can deliver mechanical cardiac impulse to the patient.

A puffer as described herein can be a mechanism to provide respiratory functions similar to CPAP. It runs on pneumatic logic, powered by HAC 134. Note: All parameters set by AHB 204 also will have valving to allow for manual overrides.

SLC 202A and 202B provides a pneumatic mechanism to elevate shoulders to maximize ribcage volume. It is regulated via AHB 204.

The SSRRS 122 can have a Position 1 that is off; a Position 2 that is Run; a Position 3 that is momentary for initial gas input, and then returns to Position 2; a Position 3 that is momentary for initial gas input and return to Position 2; and a Position 4 that is momentary for an initial spark and then return to Position 2. Position 3 may utilize a One Shot gas injection pulse to avoid repeating injection as switch returns to position 2.

An Upper Body Compression System can be powered by HAC 134. It can be attached to PPP 200 and can be zipped on patient in a manner similar to ski pants. HAC 134 supplies sufficient pressure to inflate internal air bags to provide compression to extremities to maximize blood volume to torso and head.

Vapor Relief Valve 139 can regulate operating temperature and exhaust excess thermal energy and pressurized vapor.

The water jacket 130 surrounding combustion cylinder can have direct upward connection to H₂O 128 to allow for vapor to evacuate and to be replenished by H₂O 128.

FIGS. 2A, 2B, and 2C illustrate a top view, a side view, and an end view, respectively, of a patient positioning unit 200 for use with the CPR device 100 shown in FIG. 1 in accordance with embodiments of the present disclosure. The unit 200 is configured to place the patient for administration of CPR compressions and ventilation by use of the CPR device 100.

Referring to FIG. 2A, the unit 200 can be integrated with the pulser 102 for application to the patient (e.g., administration of compressions) when the patient is placed on the unit 200. The unit 200 includes multiple mechanisms 202A, 202B, 202C, and 202D for controlling positioning of the patient's body. Particularly, mechanisms 202A and 202B are shoulder lift cylinders that can be adjusted to position the patient's shoulders. Mechanism 202C is a lower leg lift that can be adjusted to position the patient's legs. Mechanism 202D is a head support that can be adjusted to position the patient's head. Mechanism 202 can include a head rest and forehead strap for securing the patient's head in place on the unit 200.

The CPR devices disclosed herein are intended to provide automated CPR for patients suffering cardiac arrest via several functions. Particularly, a CPR device disclosed herein can deliver controlled impulse to the sternum via a pulser piston-type device (e.g., pulser 200 shown in FIGS. 1 and 2A-2C. A CPR device disclosed herein can also provide pure oxygen inhalation and exhalation via a “puffer” device utilizing pneumatic circuitry. For example, the air compressor 134 and the compressed air reservoir 136 can operate together for providing this function. Further, a CPR device described herein can provide gravity assist positioning via its mechanisms, such as the mechanism 202C to provide lower leg lifting and the mechanisms 202A and 202B to provide shoulder support and lifting. These mechanisms for gravity assist positioning can thereby maximize critical blood flow to the coronary arteries by placing the patient face down on the patient positioning unit 200.

Other example advantages of CPR devices disclosed herein are that it is portable, provides safe discharge of exhaust for enclosed environments, provides reduced noise due to H₂O reservoir cooling and baffling, and provides reduced weight and volume by use of chemical potential energy.

It is envisioned that a CPR unit as disclosed herein may be stored in a “break glass” wall hung box in a public building or office. It is noted that typical battery powered systems require frequent inspection and testing to verify charge. By utilizing stored gasses for combustion and initial pneumatic operation the maintenance interval requirements can be greatly extended. A visual inspection of the pressure gauges can verify operability.

FIGS. 2D, 2E, and 2F illustrate a top view, a side view, and an end view, respectively, of another example patient positioning unit for use with the CPR device shown in FIG. 1 in accordance with embodiments of the present disclosure. The patient positioning unit shown in FIGS. 2D, 2E, and 2F is similar to the patient positioning unit shown in FIGS. 2A, 2B, and 2C except for an adjustable height beam 204 and a shaft 206 for placement on the spine to obtain chest height measurement to sternum which can be transferred via cables to set the pulser's 102 stroke height, strength of impulse, and shoulder lift height.

It is noted that the adjustable height beam 204 can be a beam on pole or caliper mechanism to measure height from sternum to back to proportion for accurate delivery of pulser stroke depth, max pressure, and bell curve profile via connection to IMCM 136.

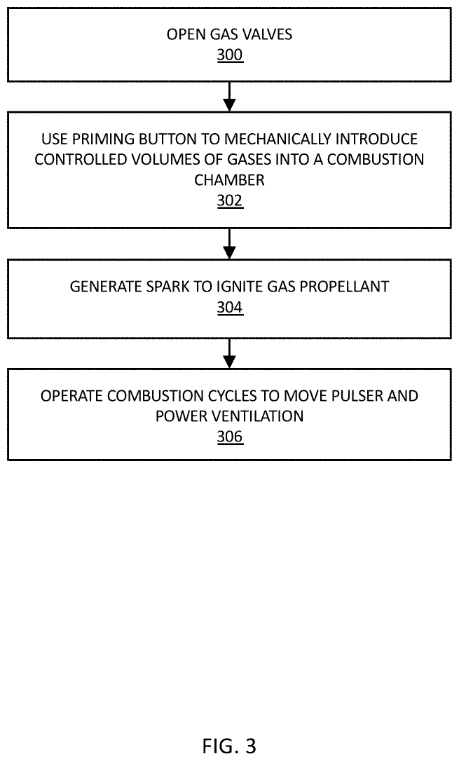

FIG. 3 illustrates a flow diagram of example operation of a CPR device in accordance with embodiments of the present disclosure. The method is described by example with the CPR device 100 shown in FIGS. 1 and 2A-2C, although it should be understood that the method may be applied to any other suitable CPR device with a combustion unit. Initially, for example, the CPR device 100 can be provided and a patient needing administration of CPR can be suitably positioned thereon.

Referring to FIG. 3, the method includes opening 300 gas valves of the CPR device. For example, valves for the hydrogen gas and oxygen gas can be opened. The method also includes using 302 a priming button to mechanically introduce controlled volumes of the gases into a combustion chamber. For example, a priming button can be operated to introduce the hydrogen and oxygen gases into the chamber 114 via linkage to IHCM 136. Valving injects predetermined volumes of the gases into the chamber 114 with each application of the input valves.

The method of FIG. 3 also includes generating 304 a spark to ignite gas propellant. Continuing the aforementioned example, the switch 122 can be rotated to generate a piezo spark to ignite the propellant to initiate the initial cycle. The switch 122 can be configured to return to the run position after start to continue operation.

The method of FIG. 3 includes operating 306 combustion cycles to move pulser and power ventilation. Continuing the aforementioned example, the CPR device 100 can operate through combustion cycles by use of the oxygen and hydrogen gases to power the pulser 102 and operate the ventilation system. Near the end of a stroke, combustion gases can exit the cylinder via cylinder ports. Further, combustion vapor can run through an internal baffle within the water reservoir 128 to reduce noise and dissipate heat. Remaining water and vapor can be released into the water reservoir 128 to recondense the stored water. A safety valve can release excess gasses and water via a drainage hose to maintain desired temperature and cyclic operation. The return of the piston to position may be via a spring return in the IHCM 136.

It is noted that during operation the initial ventilation logic can be power by the oxygen tank until the compressor delivers sufficient pressure to the air reservoir 136 to take over pneumatic operations, thereby conserving oxygen for ventilation purposes. The cycle can continue with sequenced self activation of gas priming and piezo ignition signals driven by cylinder return initiated in the IHCM 136. Operation can be stopped by setting the switch 122 to the stop position to open the ignition circuit. Further, the valves of the gases can be manually closed.

In accordance with embodiments, a secondary chamber 110 between the combustion chamber 114 and the IHCM 136 can include reed valves to act as a low pressure air pump to provide cooling air the chamber 114 and water reservoir 128.

In accordance with embodiments, administration of precise cardiac impulse can follow a Bell curve controlled by flow valves in the IHCM 136 and dampers on the pulser 102. Energy input from combustion can be set to exceed max usage with excess being hydraulicly applied to air compressor 134. Valve modules can be grouped on a manifold for simple swap out as CPR specifications change.

Positioning by the unit 200 shown in FIGS. 2A-2C can allow for easier regurgitation clearance and opens up airway for intubation once the head support is manually set. The shoulder lift can provide greater ribcage expansion. Prone positioning sets chest cavity with heart lower to allow better gravity return of blood to coronary arteries. This can be critically important because CPR moves blood through the body, but in upright position allows blood to drain away from coronary arteries and compression empties them. Prone position also uses body weight as inertial resistance to the pulser 102 strokes which eliminates complex, possible error prone strapping. If further resistance is needed weights such as sandbags can be placed on spine. This is much is quicker and simpler to implement than strap or clamp systems and quicker to undo if other trauma requires immediate attention. The system can be configured for rapid adjustment of its mechanisms for various body sizes and types.

Lower leg lift mechanism 202C can have an air cylinder at the feet connected to plate hinged at hips to elevate feet and legs so that maximum blood volume is above the heart allowing max flow to the coronary arteries. In embodiments, a bag can be placed over the legs that can be inflated with internal inflatable airbags to minimize blood flow to legs thereby maximizing blood flow between head and heart.

In accordance with embodiments, the CPR device described herein can generate linear power using piston cylinder configuration to provide ambient air compression, cooling air for combustion and hydraulic fluid pressure via single shaft referred to as a spool. A pulser (e.g., the pulser 102) uses hydraulic pressure to administer CPR cardiac impulses governed by flow valves and regulators. A “puffer” (the ventilation system) can deliver oxygen or ambient air to lungs utilizing pneumatic timing and circuitry. The device can require hydrogen, oxygen, and possibly water.

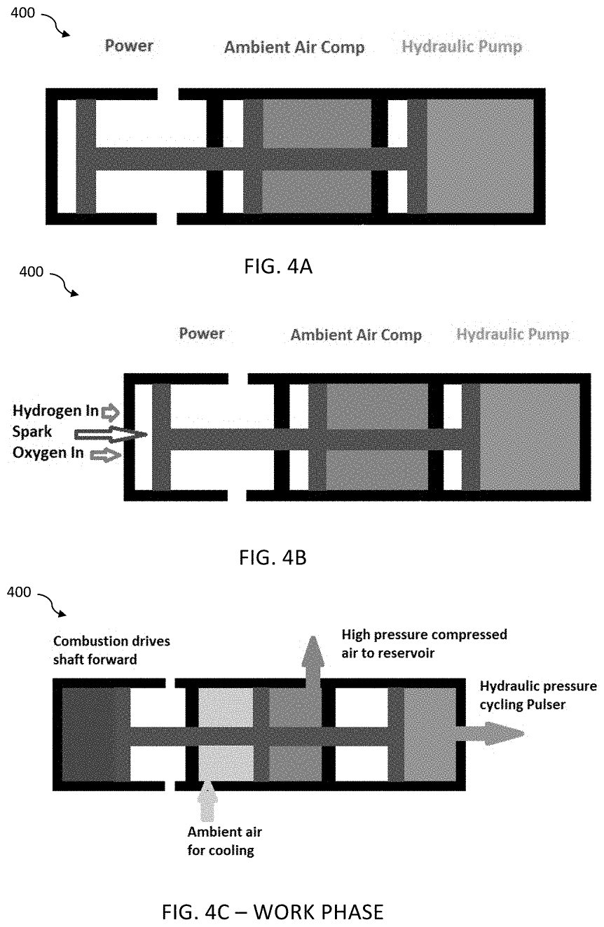

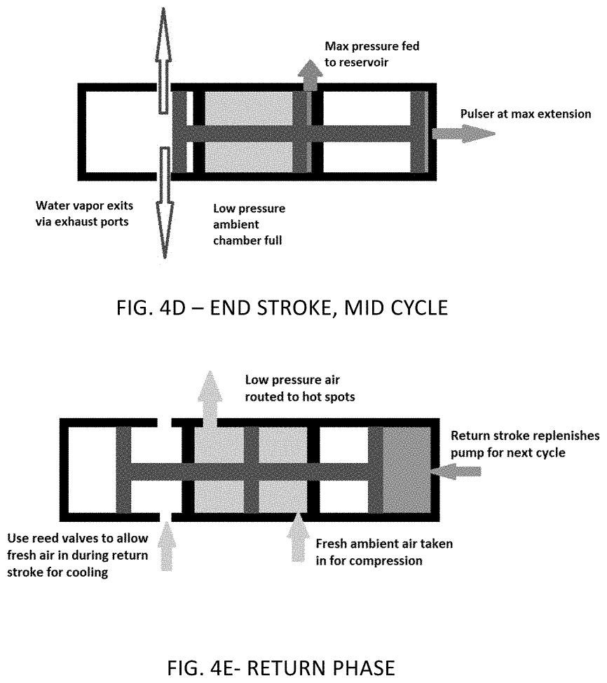

FIGS. 4A-4E illustrates diagrams of another example CPR device 400 with a combustion unit in accordance with embodiments of the present disclosure. Referring to FIG. 4A, the CPR device 400 involves a single shaft transmitting power from combustion cylinder to air compressor and hydraulic pump. Because this device may often be used in confined transports such as ambulances and medivac helicopters gaseous hydrogen and oxygen are desirable propellant components to use due to the combustion byproduct being essentially steam. The CPR device 400 shown in FIG. 4A shows the main components: power, ambient air compressor, and hydraulic pump.

The initial startup of the CPR device 400 involves setting valves and switches to GO mode then manually introducing a fixed charge of hydrogen, then oxygen followed by a manually generated push button Piezo spark generator. FIGS. 4B-4E depict the operation of the device.

The majority of water vapor will be discharged via ports. Spring return will need to allow sufficient reserve to seat spool to left. The return phase includes charging of a capacitor requiring magnets, diodes and use for ongoing ignition. Second cycle operates same as first only gas injection and spark are automated once GO switch and valves are in position.

Cooling may also be accomplished by a water jacket surrounding PPD with a high temp or pressure relief valve venting as required. Water loss is to be compensated by pulling from a reservoir tank and being pumped into jacket via pneumatic circuitry powered by the air compressor.

Distilled water injection to combustion chamber to absorb heat and increase expansion. This may also be used as coolant.

Shaping of pressure delivery bell curve can be accomplished with a valve pack that can be replaced as standards change. End of stroke determined by height differential between zero point of pulser pad and height of backing plate. Set point is adjusted mechanically set with rotational adjustment setting on a spiral ramp controlled by linkage related to height.

Use of hydrogen and oxygen to eliminate fumes in vehicles. End of stroke to be in proportion to distance between pulser pad back restraint. Face down makes regurgitation less hazardous, allows for better chest expansion, eliminates the CClamp spread on single shaft devices, negates need for multiple clamshell segments like Lucas and lets body weight work in your favor. In embodiments, a waistband belt or tight “ski pants” tubes can be used and placed from waist down with internal air bags to be inflated by compressor to increase fluid pressure in lower body thereby allowing maximum flow to heart, lungs and brain.

In accordance with embodiments, operation of the patient positioning unit 200 can begin with the patient being placed on the unit with the sternum positioned over the pulser 102. It is noted that depending on impulse delivery and patients' size and build, weighted bags may be placed to minimize body elevation during pulser stroke. This may be used rather than strapping mechanisms as it allows faster patient repositioning if needed. Subsequently, the puffer mask can be attached to the patient and the patient's head positioned in the mechanism 202D for head support. Also, mechanisms (SLC) 202A and 202B are positioned under the shoulders. Mechanism 202C may be elevated to improve gravity feed blood to the heart.

Adjustable beam 204 (or caliper type device) can obtain mechanical representation of sternum to spine depth for input to IHCM 136. Setting is locked in place, then device is offset or rotated away from patient to allow better access. There can be optional placement of LBCS and UBCS with manual procedures and valving on IHCM 136.

In accordance with embodiments, the patient positioning unit 200 can start by manually opening the gas valves. Subsequently, the SSRRS 122 can be rotated for initial propellant injection, then one step further to initialize circuit to generate spark via piezo or similar method with possible delay to allow gas injection to complete. Then the cylinder fires, and the piston is now in motion for power stroke.

Continuing operation, the piston passes exhaust port 137 in cylinder wall venting exhaust gasses to H₂O 128 through reed valves (not shown). Further, the cylinder pressure drops.

Next, via springs within IHCM 136, the piston is returned to rest position where normally closed valves within IHCM 136 can be activated by cams on the piston shaft to deliver a measured volume of hydrogen and oxygen followed by a time delayed piezo to spark to allow for completion of gas entry before combustion.

Cycle of the system can continue until interrupted by depletion of gasses or SSRRS 122 switched to off position. Subsequently, the gas valves can be manually closed.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A cardiopulmonary resuscitation device comprising:
a first mechanism configured to attach to a torso of a patient for providing chest compressions to the patient;
a second mechanism comprising a piston and a shaft, wherein the piston is movable within the shaft and is attached to the mechanism for movement of the mechanism when the piston moves within the shaft; and
a combustion unit operatively connected to the piston for powering the movement of the piston within the shaft, the combustion unit comprising a chamber configured to receive propellant, wherein the combustion unit is configured to controllably ignite the propellant in the chamber for powering the movement of the piston.

2. The cardiopulmonary resuscitation device of claim 1, wherein the piston is configured to move within the shaft to move the mechanism to a first position for contact with the torso, to move the mechanism further beyond the first position, and to retract the mechanism to a second position, and
wherein the combustion unit is configured to power the piston to move the mechanism in a controlled movement cycle between the first position and the second position.

3. The cardiopulmonary resuscitation device of claim 1, wherein the propellant comprises hydrogen and oxygen.

4. The cardiopulmonary resuscitation device of claim 3, wherein the combustion unit comprises containers configured to separately store the hydrogen and oxygen and to controllably deliver the hydrogen and oxygen to the chamber.

5. The cardiopulmonary resuscitation device of claim 1, wherein the combustion unit comprises an igniter configured to controllably ignite the propellant.

6. The cardiopulmonary resuscitation device of claim 1, a cooling unit configured to transfer heat from the second mechanism.

7. The cardiopulmonary resuscitation device of claim 6, wherein the cooling unit comprises cooling fins attached to the second mechanism.

8. The cardiopulmonary resuscitation device of claim 6, wherein the cooling unit comprises a fluid cooling unit attached to the second mechanism and configured to transfer heat from the second mechanism to fluid contained by the fluid cooling unit.

9. The cardiopulmonary resuscitation device of claim 1, further comprising an air compressor powering pneumatic circuitry to provide appropriate respiration functionality ventilation to the patient and pneumatic control of a ventilation unit.

10. The cardiopulmonary resuscitation device of claim 9, further comprising spark generation function for ignition.

11. The cardiopulmonary resuscitation device of claim 1, further comprising a controller configured to regulate the combustion unit to control powering of the movement of the piston for controlling movement of the first mechanism according to a predetermined compression regimen for the patient.

12. The cardiopulmonary resuscitation device of claim 1, further comprising a patient positioning unit for placement of the patient.

13. The cardiopulmonary resuscitation device of claim 12, wherein the patient positioning unit is integrated with the first mechanism for receipt of the first mechanism for application to the patient when the patient is placed on the patient positioning unit.

14. The cardiopulmonary resuscitation device of claim 12, wherein the patient positioning unit comprises a plurality of mechanisms for controlling positioning of the patient's body.

15. A method of cardiopulmonary resuscitation, the method comprising:
providing a cardiopulmonary resuscitation device comprising:
a first mechanism for providing chest compressions to a patient;
a second mechanism comprising a piston and a shaft, wherein the piston is movable within the shaft and is attached to the mechanism for movement of the mechanism when the piston moves within the shaft; and
a combustion unit operatively connected to the piston for powering the movement of the piston within the shaft, the combustion unit comprising a chamber configured to receive propellant, wherein the combustion unit is configured to controllably ignite the propellant in the chamber for powering the movement of the piston; and
attaching the first mechanism to a torso of the patient; and
operating the combustion unit to ignite and combust propellant in the chamber for moving the piston within the shaft to thereby move the first mechanism for providing chest compressions to the patient.

16. The method of claim 15, wherein the piston is configured to move within the shaft to move the mechanism to a first position for contact with the torso, to move the mechanism further beyond the first position, and to retract the mechanism to a second position, and
wherein the combustion unit is configured to power the piston to move the mechanism in a controlled movement cycle between the first position and the second position.

17. The method of claim 15, wherein the propellant comprises hydrogen and oxygen.

18. The method of claim 17, wherein the combustion unit comprises containers configured to separately store the hydrogen and oxygen and to controllably deliver the hydrogen and oxygen to the chamber.

19. The method of claim 15, further comprising controllably igniting the propellant.

20. The method of claim 15, a cooling unit configured to transfer heat from the second mechanism.

21. The method of claim 20, wherein the cooling unit comprises cooling fins attached to the second mechanism.

22. The method of claim 20, wherein the cooling unit comprises a fluid cooling unit attached to the second mechanism and configured to transfer heat from the second mechanism to fluid contained by the fluid cooling unit.

23. The method of claim 15, further comprising an air compressor configured to provide ventilation to the patient.

24. The method of claim 23, further comprising an electrical unit configured to convert mechanical power generated by the combustion unit to electrical power to generate ignition spark

25. The method of claim 15, further comprising regulating the combustion unit to control powering of the movement of the piston for controlling movement of the first mechanism according to a predetermined compression regimen for the patient.

26. The method of claim 15, further comprising a patient positioning unit for placement of the patient.

27. The method of claim 26, wherein the patient positioning unit is integrated with the first mechanism for receipt of the first mechanism for application to the patient when the patient is placed on the patient positioning unit.

28. The method of claim 26, wherein the patient positioning unit comprises a plurality of mechanism for controlling positioning of the patient's body.
